(19) United States
(12) Patent Application Publication
(10) Pub. No.: US 2024/0403821 A1
(43) Pub. Date: Dec. 5, 2024

(54) scan organizing system

(71) Applicant: Wayne A. Williams, JR., Florence, AZ (US)

(72) Inventor: Wayne A. Williams, JR., Florence, AZ (US)

(21) Appl. No.: 18/328,887

(22) Filed: Jun. 5, 2023

(51) Int. Cl. G06Q 10/087; G06K 7/14; G06K 19/06; G06K 19/07

(52) U.S. Cl. CPC G06Q 10/087; G06K 7/1417; G06K 19/06037; G06K 19/0723

(57) ABSTRACT

The present invention is a system and method for managing stored things using scannable pieces/devices and a mobile application. The system includes small adhesive scannable pieces that are removably attached to storage spaces, as well as a mobile application that can scan the scannable components to access data on the items kept in the related storage spaces. Users, upon scanning the scannable pieces which contain item lists, find, and manage their stored goods using the mobile application without having to physically open and look through storage spaces. The scannable components are lightweight, adaptable, and simple to attach and detach from storage areas. The method makes things easier for users and can be used for inventory control and item identification in warehouses.

### CROSS-REFERENCE TO RELATED APPLICATION

The present application claims priority to, and the benefit of, U.S. Provisional Application No. 63/349,193, which was filed on Jun. 6, 2022, and is incorporated herein by reference in its entirety.

### FIELD OF THE INVENTION

The present invention relates generally to the field of scanning applications and items organizing systems. More specifically, the present invention relates to a novel system for efficient organization and identification of stored items using small adhesive and customizable scannable pieces and a mobile application. The scannable pieces are attached to storage spaces and include information of stored items in the storage space. The mobile application scans the scannable piece to display a list of stored items. Accordingly, the present disclosure makes specific reference thereto. Nonetheless, it is to be appreciated that aspects of the present invention are also equally applicable to other like applications, devices, and methods of manufacture.

### BACKGROUND

By way of background, in the modern world, individuals keep a variety of things at different places including. but not limiting to. boxes, drawers, cabinets, and refrigerators, among other places. But, remembering what is kept where is a difficult chore. Individuals frequently forget what they put in a particular storage space, and it can be tedious and time-consuming to hunt through multiple boxes and drawers. This is a common problem in homes as well as in businesses, warehouses, and more. Furthermore, when a person cannot find the precise item they are seeking, the person becomes frustrated.

Even when individuals are aware of the objects they have put in a certain location, physically scouring the area for them can often be time consuming and a nuisance. For instance, if someone needs a specific item from a box in the garage, they might have to go through several boxes before finding the one they need, and sometimes they might even forget which box the item is in. Forgetting what is kept in the pantry, refrigerator, or other food storage facilities is another frequent issue. This may cause consumers to buy more products (i.e., duplicate products) they do not need, wasting money, and perhaps resulting in food waste if the items expire before being used.

Conventionally, individuals write item names on slips and paste them on drawers or other storage areas. Some individuals write names of the items directly on the storage space. However, such methods are ineffective and cause damage to the storage space. It is obvious that there is a need for a more effective method of managing and organizing stored items, especially in terms of lowering frustration levels and saving time.

Therefore, there exists a long-felt need in the art for a system that overcomes the shortcomings of the methods used in the prior art for identifying and locating stored items. There is also a long-felt need in the art for a system that eliminates individuals sifting through storage areas for identifying items. Additionally, there is a long-felt need in the art for an items identification system that eliminates requirement of opening storage spaces for locating items. Moreover, there is a long-felt need in the art for a system that enables users to use their smartphones to locate stored items. Further, there is a long-felt need in the art for a system that eliminates use of manual slips and markings on storage spaces for identification of items. Furthermore, there is a long-felt need in the art for an item organizing system that can be used with any type of storage space for easily locating items stored therein. Finally, there is a long-felt need in the art for an item organizing system that offers a way to easily identify items stored within an area without having to open the containers in the area and sift through same.

The subject matter disclosed and claimed herein, in one embodiment thereof, comprises an item organization and identification system. The system is used for easily identifying items stored within an area without having to open the area and sift through same. The system includes a computer-implemented software application installed in a handheld user device, at least one small adhesive plastic scannable device, the scannable device being designed to be removably attached to a storage area using an adhesive layer, the scannable device has a scannable code, including the information of the items stored in the storage area on which the scannable device is attached, the encoded or stored information being retrieved by the software application when the scanning of the scannable device is done by the software application, and the retrieved information being displayed on a display device of the electronic device.

In this manner, the item organizing system of the present invention accomplishes all of the forgoing objectives and provides users with a software application and scannable devices/pieces for locating items stored in storage spaces. The system eliminates the need to physically open and search through storage areas, thus saving time and reducing frustration. The system also enables users to locate stored items quickly and easily by simply scanning a scannable piece attached to the storage area, thereby providing time savings and convenience. The mobile application enables for easy configuration and management of multiple scannable devices/pieces, thereby providing an efficient system for storage organization.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is later presented.

The subject matter disclosed and claimed herein, in one embodiment thereof, comprises an items organization and identification system. The system further comprising a computer-implemented software application installed in a handheld user device, at least one small adhesive plastic scannable device, the scannable device being designed to be removably attached to a storage area using an adhesive layer, the scannable device has a machine-scannable code including the information of the items stored in the storage area on which the scannable device is attached, the encoded or stored information being retrieved by the software application when the scanning of the scannable device is done by the software application, and the retrieved information being displayed on a display device of the electronic device. The scannable device is customizable for providing personalization and identification.

In yet another embodiment, a small adhesive scannable device configured to be encoded with information of items is disclosed. The scannable device is scanned by a software application for retrieving the information associated with the respective items. The scannable device includes a customizable front surface that is tear resistant, washable, and can be cleaned using any cloth, the customizable front surface being coated with a material that can be easily erased or rubbed off and can withstand multiple erasures and rewrites, an invisible machine-scannable code disposed underneath the front surface, wherein the scannable code is configured to store the items' information therein, the scannable code not being visible from outside, thus making the scannable device look like a conventional sticker to users, and an adhesive layer configured to attach the scannable device to a storage surface.

In yet another embodiment, a method for inventory management by identifying items stored in a storage space is described. The method comprising the steps of providing a software application installed in a handheld electronic device, selecting a digital scannable device/piece from a plurality of templates provided within the scan organizer application, configuring a plurality of items to be associated with the selected digital scannable piece by providing names and/or quantities of items to be stored in a storage space to which the scannable piece is to be attached, printing the configured digital scannable piece on an adhesive paper, removably attaching the printed digital scannable piece to the storage space for which it is configured, and scanning the attached digital scannable piece using the software application any later time to identify the details of the associated stored items in the storage space without opening the storage space.

In yet another embodiment, an item scanning and identification system is disclosed. The system comprising a plurality of lightweight and customizable scannable pieces and a mobile application, provides a convenient and efficient way for users to identify and manage items stored in a storage space without having to physically open and sift through the storage space. The system operates by adhering a scannable piece to the exterior surface of a storage space such as a container, scanning the scannable piece using the mobile application to retrieve stored items information, and displaying details of the stored items on the display of the electronic device.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of an items organization and identification system of the present invention in accordance with the disclosed architecture;

FIG. 2 illustrates a perspective view showing an exemplary scannable device used in the organization and identification system of the present invention and showing essential components thereof in accordance with the disclosed architecture;

FIG. 3 illustrates a flow diagram depicting a process of customizing a scannable piece used in the present invention as per preferences of a user in accordance with the disclosed architecture;

FIG. 4 illustrates a flow diagram depicting a process of scanning a scannable piece using the scan organization mobile application of the present invention in accordance with the disclosed architecture;

FIG. 5 illustrates a perspective view showing different steps in using the system and the application of the present invention in accordance with the disclosed architecture;

FIG. 6 illustrates a flow diagram depicting a process of configuring and using a scannable piece using the scan organization mobile application in accordance with the disclosed architecture;

FIG. 7 illustrates a flow diagram depicting another process of configuring and using a scannable piece using the scan organization mobile application in accordance with the disclosed architecture;

FIG. 8 illustrates an exemplary user interface displayed by the software application providing a variety of options to users for operating and configuring scannable pieces in accordance with the disclosed architecture; and

FIG. 9 illustrates an exemplary user device that is used for installing the scan organizer software application of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a system that overcomes the shortcomings of the methods used in prior art for identifying and locating stored items. There is also a long-felt need in the art for a system that eliminates individuals sifting through storage areas for identifying items. Additionally, there is a long-felt need in the art for an items identification system that eliminates requirement of opening storage spaces for locating items. Moreover, there is a long-felt need in the art for a system that enables users to use their smartphones to locate stored items. Further, there is a long-felt need in the art for a system that eliminates use of manuals slips and markings on storage spaces for identification of items. Furthermore, there is a long-felt need in the art for an item organizing system that can be used with any type of storage space for easily locating items stored therein. Finally, there is a long-felt need in the art for an item organizing system that offers a way to easily identify items stored within an area or container without having to open the area or container and sift through same.

The present invention, in one exemplary embodiment, is an item scanning and identification system. The system comprising a plurality of lightweight and customizable scannable pieces and a mobile application, provides a convenient and efficient way for users to identify and manage items stored in a storage space without having to physically open and sift through the storage space. The system operates by adhering a scannable piece to the exterior surface of a storage space such as a container, scanning the scannable piece using the mobile application to retrieve stored items information, and displaying details of the stored items on the display of the electronic device.

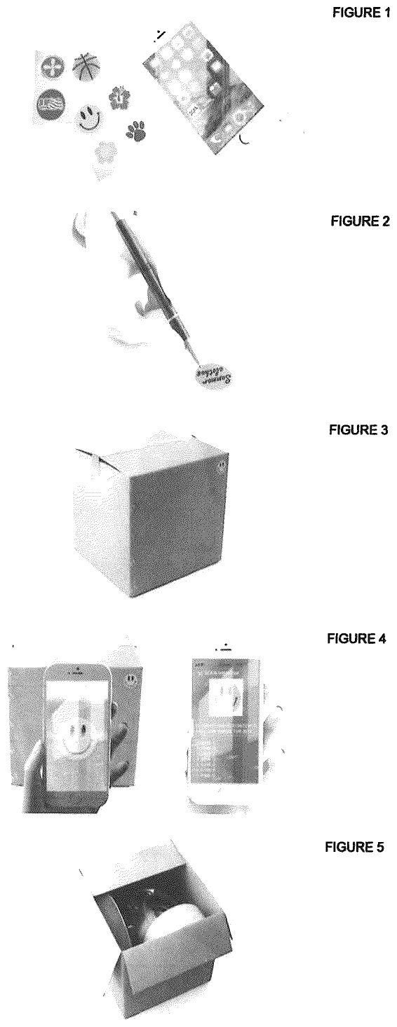

Referring initially to the drawings, FIG. 1 illustrates a schematic view of items organization and identification system of the present invention in accordance with the disclosed architecture. The items organization and identification system 100 of the present embodiment is designed to offer users a way to easily identify items stored within a storage area such as a cabinet, a drawer, a container, and any other storage area without having to open the area and sift through same. More specifically, the system 100 includes a computer-implemented software application 102 installed in a handheld user device 106 such as a smartphone and configured for scanning one or more small adhesive plastic scannable devices 104. The scannable device 104 is designed to be attached to a storage area as illustrated in FIG. 5 using an adhesive layer which is shown in FIG. 2. The scannable device 104 is a passive device and includes the information of the items stored in the storage area on which the scannable device 104 is attached. The encoded or stored information is retrieved by the software application 102 when the scanning of the scannable device 104 is done using an appropriate communication channel 108 including, but not limited to, NFC or RFID. The retrieved information is displayed on display device of the electronic device 106 as illustrated in FIG. 5.

The scan organizer application 102 is installed in the handheld electronic device 106 and can be downloaded from any play store or app store. The application 102 provides a plurality of options to the users as described in FIGS. 6, 7, and 8 of the present disclosure for enabling the users to configure and scan the scannable devices. Further, the scannable device 104 is customizable as described in FIG. 3 for providing a personalization and identification to the scannable device 104.

Examples of the handheld electronic device 106 can include, but not limited to, a desktop, a notebook, a laptop, a handheld computer, a touch sensitive device, a computing device, a smartphone, and/or a smartwatch. It will be apparent to a person of ordinary skill in the art that the handheld electronic device 106 can include any device/apparatus that is capable of manipulation by the user. It should be appreciated that pairing between the application 102 and the scannable piece 104 is not required for scanning the scannable piece 104 and thus the process of identifying items is easy and convenient and can be done by individuals of all ages.

FIG. 2 illustrates a perspective view showing an exemplary scannable device used in the organization and identification system 100 of the present invention and showing essential components thereof in accordance with the disclosed architecture. The scannable device 104 is especially designed to be lightweight, passive and include information of items stored in a storage area. For customization and aesthetic purposes, the scannable device 104 has a customizable front surface or layer 202. The customizable front surface or layer 202 is tear resistant, washable and can be cleaned using any cloth. Further, any design can be drawn or printed on the front surface or layer 202 by a user for customization.

The customizable front surface or layer 202 of the scannable piece 104 is coated with a material that can be easily erased or rubbed off and can withstand multiple erasures and rewrites. The writing means used to draw on the customizable front surface of the scannable piece can include various types of pens or markers and may be water-resistant or permanent depending on the user's preference.

An invisible machine-scannable code 204 configured to store the items information therein is disposed underneath the front surface or layer 202. The scannable code 204 can be any machine-scannable code known in the art including, but not limited to, QR code, barcode, and the like. Further, the scannable code 204 is not visible (i.e., obfuscated or obscured) to the observer/user, thus, making the scannable device 104 look like a conventional sticker to users. The scanner code 204 can be embossed using a conventional means such as thermal printing or any other process on the rear side of the front surface or layer 202.

For removably attaching the scannable device 104 on a surface, an adhesive layer 206 is disposed in the scannable device 104. The adhesive layer 206 is pressure sensitive, waterproof and is preferably made of polyurea resin. The dimensions of the front surface or layer 202 and the adhesive layer 206 are substantially the same.

FIG. 3 illustrates a flow diagram depicting a process of customizing a scannable piece used in the present invention as per preferences of a user in accordance with the disclosed architecture. Initially, a scannable piece/device is selected from a set of available pieces/devices (Step 302). The scannable pieces are made from a durable and lightweight material that is easy to attach to a variety of surfaces. Then, text/design on the customizable front surface of the scannable piece is erased using an eraser or rubbing tool (Step 304). Thereafter, a customized and personalized design or text is drawn on the front surface using a writing means by a user (Step 306). Finally, the customized scannable piece is removably attached on a storage area, such as a cabinet or box, using adhesive backing on the back of the scannable piece. The adhesive backing on the back of the scannable piece is strong enough to keep the piece in place but can be easily removed without leaving residue or damaging the surface.

FIG. 4 illustrates a flow diagram depicting a process of scanning a scannable piece using the scan organization mobile application of the present invention in accordance with the disclosed architecture. Initially, a desired scannable piece is adhered on an exterior surface of a storage space or array (Step 402). Then, as illustrated in FIG. 5, the adhesive scannable piece is scanned using the mobile application installed in an electronic device for retrieving stored items information in the scannable piece (Step 404). Finally, details of the stored items are displayed on a display of the electronic device, thereby enabling a user to find items without opening the storage space and thus provides convenience to users (Step 406). It should be noted that the system 100 and scannable pieces 104 of the present invention can be used in inventory management and identification of items in warehouses.

FIG. 5 illustrates a perspective view showing different steps in using the system 100 and the application 102 of the present invention in accordance with the disclosed architecture. As shown by arrow A, the application 102 provides Scan option 502 for using image sensor of the electronic device 106 for scanning a scannable piece. Then, as shown by arrow B, the application 102 scans the scannable piece 104 adhered on a storage space 504 for retrieving information of items stored in the storage space 504. Once successful scanning is done, the user interface 506 of the application 102 displays the list of items 508 stored inside the storage space 504 for ready reference and review by a user.

FIG. 6 illustrates a flow diagram depicting a process of configuring and using a scannable piece using the scan organization mobile application in accordance with the disclosed architecture. Initially, the scan organizer application is installed in an electronic device of a user (Step 602). Then, within the application, a digital scannable piece is selected by a user (Step 604). In the present embodiment, a plurality of templates of the scannable pieces are provided from which one template is selected by the user. Once a digital scannable piece is selected, then, a plurality of items is configured with the scannable piece (Step 606). It should be noted that the names and/or quantities of items stored in a storage space on which the scannable piece is to be attached are configured with the scannable piece. Post configuration, the scannable piece is printed using any conventional adhesive paper (Step 608). Thereafter, the scannable piece is removably attached on the storage space for which the scannable piece is configured (Step 610). Finally, the scannable piece is scanned using the mobile application any later time to identify the details of the stored items in the storage space (Step 612).

FIG. 7 illustrates a flow diagram depicting another process of configuring and using a scannable piece using the scan organization mobile application in accordance with the disclosed architecture. In the present embodiment, a physical scannable piece is configured and then scanned by a user. Initially, an unconfigured physical scannable piece is selected by a user (Step 702). Then, using the mobile application and the Configure option (as illustrated in FIG. 8), the user scans the scannable piece (Step 704) and configures (i.e., associates) same with a list of items (Step 706). After configuration, the scannable piece is removably attached on a storage area storing the configured items (Step 708) such that any user can scan the scannable piece to retrieve a list of items associated therewith (Step 710).

FIG. 8 illustrates an exemplary user interface 800 displayed by the software application 102 providing a variety of options to users for operating and configuring scannable pieces in accordance with the disclosed architecture. As illustrated, the scan option 802 (can be or different than option 502 of FIG. 5) enables a user to activate imaging sensor or camera of the electronic device illustrated in FIGS. 1 and 9 for scanning a scannable piece. The configure option 804 enables a user to configure a digital scannable piece or a physical scannable piece with the list of items associated with the scannable piece. The print option 806 enables list of items and/or a digital scannable item to be printed for enabling a user to attach the scannable item on a storage space.

FIG. 9 illustrates an exemplary user device 106 that is used for installing the scan organizer software application 102 of the present invention in accordance with the disclosed architecture. The processing unit 902 may include suitable logic, instructions, circuitry, interfaces, and/or codes for executing various operations, such as the operations associated with the user device 106, or the like. The processing unit 902 may be configured to control one or more operations executed by the user device 106 in response to the input received at the user device 106 from the user. The processor 902 executes the computer readable instructions stored in the application 102. Examples of the processing unit 902 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), and the like. Embodiments of the present disclosure are intended to include or otherwise cover any type of the processing unit 902 including known, related art, and/or later developed processing units. The user device 106 can further include one or more computer executable applications configured to be executed by the processing unit 902. The one or more computer executable applications may include suitable logic, instructions, and/or codes for executing various operations. The one or more computer executable applications may be stored in the memory 908. The one or more computer executable applications includes the application 102.

The user device 106 includes input device(s) 904 such as a touch input device, voice input device, etc. for entering data and information. Preferably, the touch interface of the user device 106 is used as the input and various buttons/tabs shown on the application 102 are pressed or clicked by the user. Other input devices such as camera and microphone are used during video chatting by the user. The display of the user device 106 also acts as the output device 906 for displaying various contents (i.e., text, images, videos, icons, and/or symbols, etc.) to the user. The display can include a touch screen, and may receive, for example, a touch, gesture, proximity, or hovering input using an electronic pen or a part of a user's body.

Electronic device 106 has memory 908 used for storing programs (sequences of instructions) or data (e.g., program state information) on a temporary or permanent basis for use in the computer system. Memory 908 can be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. The processor 902, in combination with one or more of memory 908, input device(s) 904, output device(s) 906 is utilized to provide users to execute instructions on the application 102.

Certain terms are used throughout the following description and claims to refer to particular features or components. As one skilled in the art will appreciate, different persons may refer to the same feature or component by different names. This document does not intend to distinguish between components or features that differ in name, but not structure or function. As used herein “item organizing system”, “items organization and identification system”, “organizing system”, and “system” are interchangeable and refer to the items organization and identification system 100 of the present invention.

Notwithstanding the forgoing, the items organization and identification system 100 of the present invention can be of any suitable size and configuration as is known in the art without affecting the overall concept of the invention, provided that it accomplishes the above-stated objectives. One of ordinary skill in the art will appreciate that the items organization and identification system 100 as shown in the FIGS. Are for illustrative purposes only, and that many other configurations of the items organization and identification system 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above, includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An items organization and identification system comprising:
a computer-implemented software application installed in a handheld user device;
wherein said handheld user device configured for scanning a scannable device;
wherein said scannable device attached to a storage area;
wherein said scannable device having stored information of the items stored in said storage area;
wherein said stored information becomes retrieved information by said computer-implemented software application when said scanning of said scannable device;
wherein said retrieved information is displayed on a display screen of said handheld user device;
wherein said stored information identifying items stored within said storage area; and
further wherein said stored information is an inventory of said items stored within said storage area.

2. The items organization and identification system of claim 1, wherein said handheld user device is a smartphone.

3. The items organization and identification system of claim 2, wherein said scannable device is a plastic device adhesively attached to said storage area.

4. The items organization and identification system of claim 3, wherein said scannable device is a passive device including an adhesive layer for attaching to said storage area.

5. The items organization and identification system of claim 4, wherein said storage area is selected from a group consisting of a cabinet, a drawer, and a container.

6. The items organization and identification system of claim 5, wherein said scanning having a communication channel selected from NFC and RFID.

7. The items organization and identification system of claim 1, wherein said handheld user device selected from a group consisting of a notebook computer, a laptop computer, a handheld computer, a touch sensitive device, and a smartwatch.

8. The items organization and identification system of claim 4, wherein said scannable device having a customizable front surface coated with a material for erasing and rewriting information thereon.

9. The items organization and identification system of claim 4, wherein said scannable device having a scannable code selected from a group consisting of a QR code and a barcode.

10. The items organization and identification system of claim 9, wherein said scannable device having a front surface overlaying said scannable code.

11. The items organization and identification system of claim 10, wherein said front surface obfuscates said scannable code to an observer.

12. The items organization and identification system of claim 11, wherein said front surface mimics a conventional sticker.

13. The items organization and identification system of claim 12, wherein said adhesive layer comprising a pressure sensitive polyurea resin.

14. An items organization and identification system comprising:
a computer-implemented software application installed in a handheld user device;
wherein said handheld user device configured for scanning a scannable device;
wherein said scannable device attached to a storage area;
wherein said scannable device having stored information of the items stored in said storage area;
wherein said stored information becomes retrieved information by said computer-implemented software application when said scanning of said scannable device;
wherein said retrieved information is displayed on a display screen of said handheld user device;
wherein said stored information identifying items stored within said storage area;
wherein said stored information is an inventory of said items stored within said storage area;
wherein said scannable device is a passive device including an adhesive layer for attaching to said storage area;
wherein said handheld user device selected from a group consisting of a smartphone, a notebook computer, a laptop computer, a handheld computer, a touch sensitive device, and a smartwatch; and
further wherein said scanning having a communication channel selected from NFC and RFID.

15. The items organization and identification system of claim 14, wherein said storage area is selected from a group consisting of a cabinet, a drawer, and a container.

16. The items organization and identification system of claim 15, wherein said scannable device having a customizable front surface coated with a material for erasing and rewriting information thereon.

17. The items organization and identification system of claim 16, wherein said scannable device having a scannable code selected from a group consisting of a QR code and a barcode.

18. The items organization and identification system of claim 17, wherein said scannable device having a front surface overlaying said scannable code.

19. The items organization and identification system of claim 18, wherein said front surface obfuscates said scannable code to an observer.

20. An items organization and identification system comprising:
a computer-implemented software application installed in a handheld user device;
wherein said handheld user device configured for scanning a scannable device;
wherein said scannable device attached to a storage area;
wherein said scannable device having stored information of the items stored in said storage area;
wherein said stored information becomes retrieved information by said computer-implemented software application when said scanning of said scannable device;
wherein said retrieved information is displayed on a display screen of said handheld user device;
wherein said stored information identifying items stored within said storage area;
wherein said stored information is an inventory of said items stored within said storage area;
wherein said scannable device is a passive device, including an adhesive layer for attaching to said storage area;
wherein said handheld user device selected from a group consisting of a smartphone, a notebook computer, a laptop computer, a handheld computer, a touch sensitive device, and a smartwatch;
wherein said scanning having a communication channel selected from NFC and RFID;
wherein said scannable device having a scannable code selected from a group consisting of a QR code and a barcode;
wherein said scannable device having a front surface overlaying said scannable code; and
further wherein said front surface obfuscates said scannable code to an observer.
